(19) United States
(12) Patent Application Publication
(10) Pub. No.: US 2026/0125048 A1
(43) Pub. Date: May 7, 2026

(54) METHOD AND APPARATUS FOR DETERMINATION OF AUTONOMOUS PARKING ROUTE

(71) Applicants: Hyundai Motor Company, Seoul (KR); Kia Corporation, Seoul (KR)

(72) Inventors: Jang Shin Kim, Hwaseong-si (KR); A Jeong Choi, Hwaseong-si (KR)

(21) Appl. No.: 19/231,926

(22) Filed: Jun. 9, 2025

(30) Foreign Application Priority Data
Nov. 4, 2024 (KR) 10-2024-0154528

(51) Int. Cl. B60W 30/06; G01C 21/00; G01C 21/34; G01C 21/36

(52) U.S. Cl. CPC B60W 30/06; G01C 21/3446; G01C 21/3461; G01C 21/3685; G01C 21/3811; B60W 2556/10; B60W 2556/40; B60W 2556/45

(57) ABSTRACT

An embodiment a computer-implemented method for setting an autonomous parking route includes generating an autonomous parking route by a first route generation method using a parking space and a surrounding space; generating an autonomous parking route by a second route generation method using a cloud center and a pre-trained spatial recognition deep learning model; generating an autonomous parking route by a third route generation method using a pre-trained route generation deep learning model installed in a controller of a vehicle; performing virtual driving along the routes generated by the first, second, and third route generation methods; and determining set routes in accordance with a preset route priority in the vehicle performing autonomous parking for passed routes when the virtual driving is passed.

### CROSS-REFERENCE TO RELATED APPLICATIONS

This application claims the benefit of and priority to Korean Patent Application No. 10-2024-0154528, filed on Nov. 4, 2024, in the Korea Intellectual Property Office, the entire contents of which are incorporated herein by reference.

### TECHNICAL FIELD

The present disclosure relates to a method and apparatus for determination of an autonomous parking route.

### BACKGROUND

The following description simply provides only the background information related to the present embodiment without configuring the related art.

An autonomous vehicle is a vehicle that can drive on the road by itself without human intervention. An autonomous vehicle perceives environments, sets routes, and controls driving using various sensors and control systems. Autonomous parking refers to a process in which an autonomous vehicle searches for a parking space, moves into the parking space, and completes parking by itself without human intervention. Autonomous parking reduces the driver's parking burden, especially in narrow parking spaces or complex environments, and enables safer and more efficient parking.

An autonomous parking system can operate smoothly by utilizing communication between a vehicle and a parking facility control center. A parking facility control center monitors real-time information of a parking facility, the location of empty spaces, and the location and status of vehicles, and assigns appropriate parking spaces to autonomous vehicles. A parking facility control center communicates with vehicles using a communication technology such as vehicle-to-everything (V2X), and provides information on obstacles or road conditions during a parking process, thereby enhancing safety of autonomous parking.

An autonomous parking system requires advanced control capabilities, so an Advanced Driver Assistance System (ADAS) controller is used. The ADAS controller controls the vehicle's speed, steering, and barking and accurately moves the vehicle along a parking route. The ADAS controller controls the driving status of a vehicle on the basis of collected data by analyzing, in real time, vehicle sensor information collected by an ultrasonic sensor, a camera, a radar, etc. mounted on the vehicle. Autonomous parking requires particularly precise steering control and real-time obstacle avoidance.

Deep learning technology can optimize an autonomous parking system by interacting with a parking facility control center and an ADAS controller. A deep learning model can receive data on empty parking spaces and vehicle locations in a parking facility from a control center and can set an optimal parking route. A deep learning model can precisely control a parking process by receiving data, such as the speed, the steering angle, etc. of a vehicle, in real time from a controller, and can correct or optimize a route in real time using communication with a control center.

### SUMMARY

Embodiments provide a method and apparatus for determination of an autonomous parking route. In detail, as long as unit vector information for movement of a vehicle is provided, it is possible to derive a center of rotation of the vehicle and it is possible to control movement of the vehicle, whereby it is possible to set a route for autonomous parking. Further embodiments provide setting an autonomous parking route using deep learning.

According to an embodiment of the present disclosure, a computer-implemented method for setting an autonomous parking route, the method comprising: generating an autonomous parking route by a first route generation method using a parking space and a surrounding space; generating an autonomous parking route by a second route generation method using a cloud center and a pre-trained spatial recognition deep learning model; generating an autonomous parking route by a third route generation method using a pre-trained route generation deep learning model installed in a controller of a vehicle; performing virtual driving along the routes generated by the first, second, and third route generation methods; and determining set routes in accordance with a preset route priority in the vehicle performing autonomous parking for passed routes when the virtual driving is passed. The vehicle can then be autonomously driven according to the determining.

According to another embodiment of the present disclosure, an apparatus comprises at least one memory storing commands and at least one processor. The at least one processor, by executing the commands, performs: generating an autonomous parking route by a first route generation method using a parking space and a surrounding space; generating an autonomous parking route by a second route generation method using a cloud center and a pre-trained spatial recognition deep learning model; generating an autonomous parking route by a third route generation method using a pre-trained route generation deep learning model installed in a controller of a vehicle; performing virtual driving along the routes generated by the first, second, and third route generation methods; and determining set routes in accordance with a preset route priority in the vehicle performing autonomous parking for passed routes when the virtual driving is passed.

According to an embodiment of the present disclosure, it is possible to perform autonomous parking in accordance with the setting by a user such as shortest-distance parking and minimum-step parking. Further, since the parking process information of a user is continuously used as training data for deep learning, the accuracy of setting autonomous parking route can be continuously improved.

Effects of the present disclosure are not limited to the above-mentioned effects, and other effects which are not mentioned will be clearly understood by those skilled in the art from the following description.

### BRIEF DESCRIPTION OF THE DRAWINGS

FIG. 1 is a block diagram of an apparatus for generating and following an autonomous parking route using a vehicle center and a direction vector according to an embodiment of the present disclosure.

FIG. 2 is a block diagram of an apparatus for setting an autonomous parking route according to an embodiment of the present disclosure.

FIG. 3 is an exemplary diagram illustrating a process of setting an available parking route using a spatial recognition deep learning model when a cloud center according to an embodiment of the present disclosure functions as a parking facility control center.

FIG. 4 is a diagram illustrating a process of processing training data for a route generation deep learning model.

FIG. 5 is a diagram illustrating a turning center of a vehicle based on individual wheel steering statuses.

FIG. 6 is a diagram illustrating a first route generation method according to an embodiment of the present disclosure.

FIG. 7 is a diagram illustrating a process of setting a parking route of the section Da-Ra of FIG. 6.

FIG. 8 is a diagram illustrating a process of calculating a turning center point of a vehicle.

FIG. 9 is a diagram illustrating a process of calculating individual wheel steering angles of a vehicle.

FIG. 10 is a diagram illustrating a process of setting an autonomous parking route range of the first route generation method.

FIG. 11 is a diagram illustrating an area where a vehicle center can be positioned and an area where the outermost part of the vehicle can be positioned.

FIG. 12 is a diagram illustrating a process in which a parking route is changed when an obstacle occurs inside a nearest parking route.

FIG. 13 is a diagram illustrating a process in which a parking route is changed when an obstacle occurs outside a vehicle on an outermost parking route.

FIG. 14 is a diagram illustrating a process of setting a one-step parking route according to an embodiment of the present disclosure.

FIG. 15 is a diagram illustrating a process of reducing the range of an available parking route when an obstacle occurs in a one-step parking route.

FIG. 16 is a diagram illustrating the case when one-step parking is not possible.

FIG. 17 is a diagram illustrating a multi-step parking process when there is an obstacle in front of a parking space.

FIG. 18 is a diagram illustrating a multi-step parking process when there is no obstacle in front of a parking space.

FIG. 19 is a flowchart schematically showing a method for setting an autonomous parking route according to an embodiment of the present disclosure.

FIG. 20 is a diagram schematically showing the configuration of an exemplary computing device that can be used to implement the apparatus and method described in the present disclosure.

### DETAILED DESCRIPTION OF ILLUSTRATIVE EMBODIMENTS

Some exemplary embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

The following detailed description, together with the accompanying drawings, is intended to describe exemplary embodiments of the present disclosure, and is not intended to represent the only embodiments in which the present disclosure may be practiced.

In the specification, the term ‘turning center’ refers to a rotation center point located outside a vehicle, the term ‘rotation center’ refers to the center of rotation when the vehicle turns left and right, and the term ‘vehicle center’ refers to the exact midpoint of a vehicle based on the vehicle's length or wheel base and the vehicle's width or tread.

In the specification, the term ‘outermost part of a vehicle’ includes the frontmost, the rearmost, the leftmost, and the rightmost of the vehicle and refers to the boundary used for maintaining a safety distance or for obstacle avoidance during driving.

In the specification, the term ‘parking space’ refers to a specific rectangular area where a vehicle can be parked safely. The ‘parking space’ is defined in consideration of the length or wheel base, the width or the tread, the turning radius, and the rotation radius of a vehicle.

In the specification, the term ‘parking’ is used interchangeably with ‘autonomous parking’.

In the specification, the term ‘parking line’ refers to the boundary line between a ‘parking space’ and a ‘non-parking space’.

In the specification, the term ‘parking space condition’ refers to a space in which the length and width of a parking space can accommodate the length or wheel base and the width or tread of a vehicle, there is no obstacle in the parking space, there is no obstacle in an entry path, and a vehicle can be safely and accurately parked in consideration of the turning radius, steering angle, etc. of the vehicle.

In the specification, the sign of an individual wheel steering angle is negative when the wheel is steered to the right relative to the forward direction axis of a vehicle and is positive when the wheel is steered to the left relative to the forward direction axis of the vehicle.

In the specification, the term ‘step’ refers to movement between adjacent waypoints of waypoints obtained from a parking route.

In the specification, the term ‘parking step’ refers to the number of maneuvers required to complete parking after determining a target parking space. For example, one-step parking refers to completing parking with a single maneuver and multi-step parking refers to completing parking with two or more maneuvers.

In the specification, the term ‘parking control center’ can be used interchangeably with ‘cloud center’.

In the specification, the term ‘first route generation method’, which is a route generation method according to an embodiment of the present disclosure, refers to a method of generating a route using a controller in a vehicle and is distinguished from a ‘third route generation method’ that uses an artificial intelligence model.

In the specification, the term ‘second route generation method’, which is a route generation method according to an embodiment of the present disclosure, refers to a method of generating a route using an artificial intelligence model installed in a cloud center outside a vehicle.

In the specification, the term ‘third route generation method’, which is a route generation method according to an embodiment of the present disclosure, refers to a method of generating a route using an artificial intelligence model installed in the controller in a vehicle.

In the specification, the term ‘set route’ refers to an autonomous parking route generated by the first, second, or third route generation method.

When an autonomous vehicle parks in a parking facility, it can search for empty parking spaces and select a target parking space in the parking facility, autonomously drive to the vicinity of the target parking space, and then perform autonomous parking. A process of searching for empty parking spaces and selecting a target parking space in a parking facility can be carried out by a vehicle or a parking facility control center. To move to the vicinity of a target parking space, autonomous driving can be performed along a driving route provided by a parking facility control center and/or a navigation system.

The present disclosure relates to a technology in which an autonomous vehicle performs various methods that can generate a route for autonomous parking and then performs autonomous parking on the basis of a preset priority.

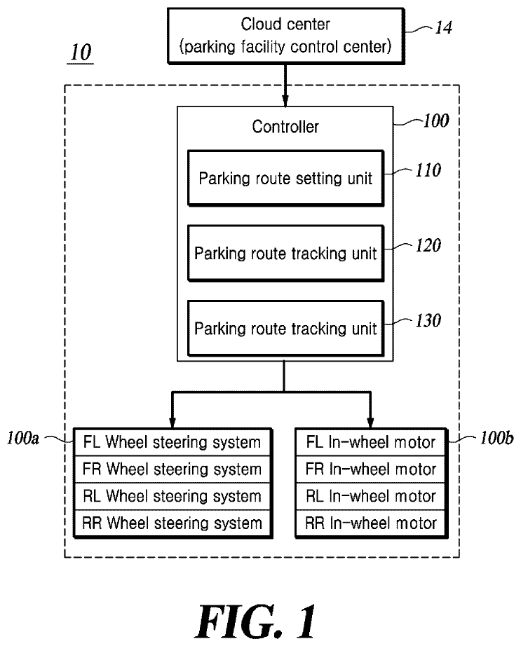

FIG. 1 is a block diagram of an apparatus for generating and following an autonomous parking route using a vehicle center and a direction vector according to an embodiment of the present disclosure.

Referring to FIG. 1, when an autonomous vehicle according to an embodiment of the present disclosure performs autonomous parking, a parking route setting unit 110 generates an autonomous parking route including information about the locations of waypoints along which the vehicle will move and the directional angles of the waypoints (first route generation method), and a parking route tracking unit 120 can calculate a rotation center of the vehicle on the basis of the direction vector of a first waypoint and the direction vector of a second waypoint and can track the autonomous parking route by controlling steering and speed of each of wheels of the vehicle using the rotation center on the basis of the generated autonomous parking route. As for the first waypoint and the second waypoint, the waypoint before movement in each step is referred to as a first waypoint and the waypoint after movement is referred to as a second waypoint.

Meanwhile, a controller 100 according to an embodiment of the present disclosure may include a route generation deep learning model 130.

A parking route generating-tracking system 10 includes a steering system 100a, an in-wheel motor 100b, and a controller 100. The parking route generating-tracking system 10 may further include various sensors (not shown) for perceiving the surrounding environment or acquiring driving information. The parking route generating-tracking system 10 may further include a communication unit (not shown) for transmitting and receiving signals or data to and from a parking facility control center 14.

The controller 100 of the autonomous vehicle according to an embodiment of the present disclosure may be an Advanced Driver Assistance System Controller (ADAS), but is not limited thereto. The controller 100 generates an autonomous parking route on the basis of information of vehicle specifications and parking facility information. The information of vehicle specifications may include a tread, a wheel base, front/rear overhangs, the maximum steering angle of the front wheels, the maximum steering angle of the rear wheels, etc.

The parking facility information is transmitted from a parking facility control center 14 when a vehicle enters the parking facility. The parking facility information may include a map of the parking facility, information about a target parking space where a vehicle will park, information about obstacles around the target parking space, information about the roads in the parking facility, etc. When the map of a parking facility is stored in the navigation system, etc. of a vehicle, the stored information may be used.

The controller 100 is disposed in the vehicle. The controller includes a hardware processor and a memory, in which the memory may store commands for executing the controller, a look-up table (LUT), etc., but is not limited thereto and may include all of configurations for general control of the parking route generating-tracking system.

Components for parking route generating and tracking can transmit or receive signals or data using various communication protocols existing in the vehicle. In this case, the communication protocols may include at least one of a Controller Area Network (CAN), a CAN with Flexible Data rate (CAN FD), a Local Interconnect Network (LIN), FlexRay, and Ethernet.

The autonomous vehicle according to an embodiment of the present disclosure can exchange data for generating an autonomous parking route through real-time communication with a cloud center 14.

The parking facility control center 14 related to the autonomous vehicle does not have a fixed standard type. The parking facility control center may be implemented in various types and depends on the purpose, scale, and application environment of the system. For example, the parking facility control center may be a distributed system, a centralized system, a cloud-based system, or an integrated system using a Vehicle-to-Everything (V2X) communication infrastructure.

A cloud-based system can communicate with vehicles and manage parking facility information using a cloud server. A cloud-based system is advantageous for processing large-scale data and updating the parking status in real time.

An integrated system using a V2X communication infrastructure enables communication between a parking facility infrastructure and a vehicle through a V2X communication technology, and the control center 14 may be operated in a distributed manner using various sensors and communication device in the parking facility.

The controller of the autonomous vehicle according to an embodiment of the present disclosure can store information such as a max parking step setting value, parking facility information, deep learning information, autonomous parking route setting values, vehicle sensor information, and vehicle specifications. The controller periodically downloads and applies deep learning training information for generating and setting parking routes from the cloud center 14. The controller 100 can generate a map of parking spaces and surrounding spaces for parking using surrounding information provided from the cloud center 14, information in the navigation system, and information verified by vehicle sensors. The controller can provide the specifications of individual vehicles to the cloud center 14.

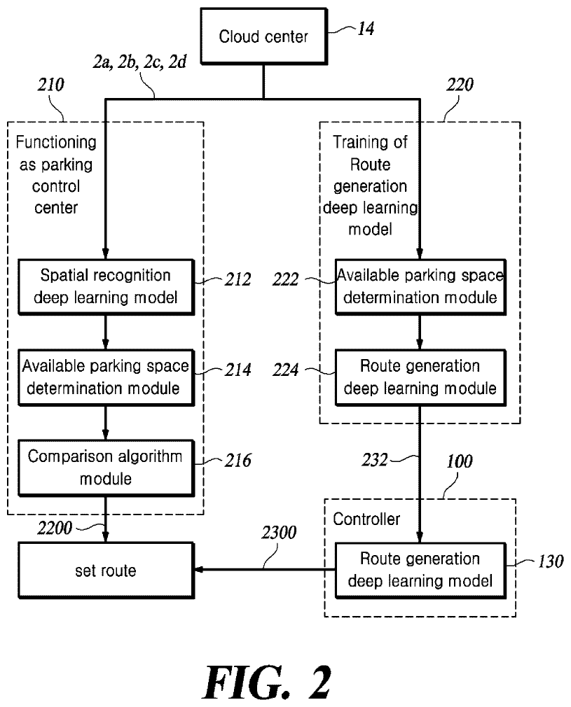

FIG. 2 is a block diagram of an apparatus for setting an autonomous parking route according to an embodiment of the present disclosure.

The cloud center 14 according to an embodiment of the present disclosure manages parking spaces of a parking facility and surrounding information of the parking spaces such as people/objects, and transmits information for generating an autonomous parking route. Further, the cloud center performs the role of a parking control center (210) and training of a parking route generation deep learning model (220).

When the cloud center 14 performs the role of a parking facility control center (210), it can set an autonomous parking route using a spatial recognition deep learning model 212 (second route generation method (2200)).

The deep learning model is composed of multiple layers and extracts and learns features of input data. When the input data passes through a network, weights and biases are adjusted, whereby prediction and classification are performed. Learning optimizes weights through backpropagation, and recognizes patterns and increases accuracy by repeating the same learning process. Features are the properties of data that is used in learning, and weights and biases are adjustment values that are used for a model to perform prediction. Backpropagation is a learning process that adjusts weights and biases to reduce a prediction error, training data refers to data that is used for model training, and input data of the data refers to values that are given to a model and target data refers to correct answers that need to be predicted.

The spatial recognition deep learning model 212 is a model that performs object detection and object classification. Object detection and object classification are computer vision techniques that play a critical role in the field of autonomous parking or autonomous driving. Object detection is a process of detecting what objects are present and where they are in an image and object classification is a process of determining what the detected objects are. That is, these techniques enable understanding of a surrounding environment of a vehicle and safe and accurate driving in implementation of autonomous parking and autonomous driving systems. For example, these techniques detect parking spaces and obstacles by scanning a surrounding environment through a camera and a LiDAR sensor, and classify people, other vehicles, road signals, etc. for setting of an appropriate parking route and safe parking.

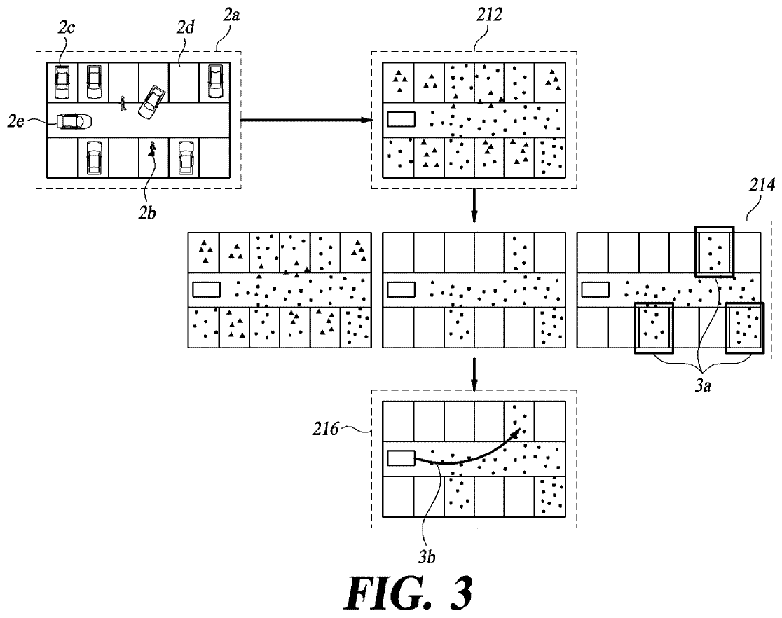

FIG. 3 is an exemplary diagram illustrating a process of setting an available parking route using a spatial recognition deep learning model when a cloud center according to an embodiment of the present disclosure functions as a parking lot control center.

In the training data of the spatial recognition deep learning model 212, the input data is a parking facility map (2a of FIG. 2) that the cloud center 14 manages and the target data are people (2b of FIG. 2), vehicles (2c of FIG. 2), and empty spaces (2d of FIG. 2). The spatial recognition deep learning model is pre-trained using training data and updates weights by periodically performing learning. When parking space and surrounding map information is input to the trained model, people, vehicles, and other objects are detected and classified, and information is transmitted to an available parking space determination module 214.

The available parking space determination module 214 does not include information about people, vehicles, and other objects, parking lines, and empty spaces with people, vehicles, and other objects in a parking space of information received from the spatial recognition deep learning model, in empty space information. It determines an area filled with empty spaces inside parking lines as an available parking space. It transmits information of the location of the subject vehicle (2e of FIG. 2), available parking spaces (3a of FIG. 3), empty spaces, etc. to a comparison algorithm module 216.

The comparison algorithm module 216 compares parking routes that can be generated in the area transmitted from the available parking space determination module with parking route generation history information that the cloud center manages, thereby transmitting an available parking route as a set route (3b of FIG. 3).

The cloud center 14 receives autonomous parking driving path/surrounding map information, error data in setting of routes, parking completion data from all of vehicles with which the cloud center 14 communicates, and manages them through a parking route generation history information management module 222 and uses them as training data for a route generation deep learning model 224. It periodically wirelessly transmits learned weights to all of the vehicles. It sets a route using a map about parking space conditions of the parking facility for individual vehicle types, vehicle conditions, and obstacle conditions, and the information of the cloud center, and transmits the route to a corresponding vehicle type.

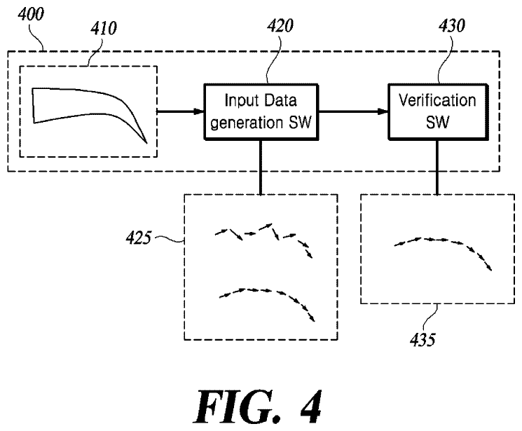

FIG. 4 is a diagram illustrating a process of processing training data for a route generation deep learning model.

In training data that is used for pre-training of the route generation deep learning model 224, route vector data 425 is generated by providing a parking route range 410 to input data generation software 420, the route vector data are input to verification software 430 to verify whether they are available parking routes 435, as in Table 1, and then a selected route is labeled.

TABLE 1

| Route | Verification result |
|---|---|
| Route 1 | x |
| Route 2 | ∘ |

The input data generation software 420 is software that generates a route vector 425 when the range of a parking route is given. The verification software 430 is software that checks whether the route data 425 generated by the software 420 generating input data is feasible for parking during autonomous parking. As a result, the route generation deep learning model is trained by using the parking route range 410 of the training data as input data and the available parking route 435 as target data.

After the pre-training, a parking route range received from the vehicle is used as input data and a successfully parked route from a virtual driving and parking result is used as target data.

As deep learning model training, an updated weight 232 may be periodically wirelessly transmitted to the controllers of all of the vehicles that communicate. Accordingly, the controller 100 stores the weight 232 provided from the cloud center 14 in the pre-trained route generation model 130, and until the weight 232 is updated, the controller generates a route using the weight 232 stored in the controller (third route generation method (2300)). However, the deep learning model installed in the controllers 100 of the receiving vehicles is not separately trained.

The controller 100 according to the autonomous vehicle according to an embodiment of the present disclosure generates an autonomous parking route and calculates the rotation angle of each wheel to track the generated autonomous parking route, thereby being able to control steering of each of the wheels. Further, the controller 100 calculates the speed of each of the wheels and controls the frequency of the power supplied to in-wheel motors, thereby being able to control the speed of each of the wheels.

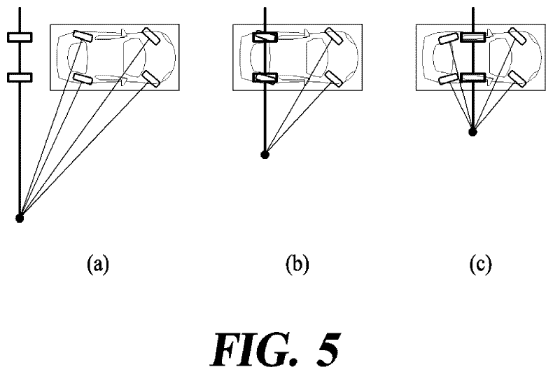

FIG. 5 is a diagram illustrating a turning center of a vehicle based on the individual wheel steering statuses.

Referring to FIG. 5, the turning radius varies depending on the steering types of vehicles and it is possible to improve driving stability and convenience by selecting an appropriate steering system for a driving situation. FIG. 5(a) shows a turning center when the rear-wheel steering angle is in-phase with the front-wheel steering angle in a vehicle equipped with a rear-wheel steering system. The vehicle moves smoothly in the lateral direction and the directional change of the vehicle body is minimized. This is useful when changing lanes at a high speed or changing lanes without a sudden direction change. However, since the rotation center of the vehicle is at the front, the turning radius increases. FIG. 5(b) shows the turning center of a vehicle without a rear-wheel steering system, that is, a vehicle that can steer only the front wheels. The vehicle rotates around the rear axle, so it has a typical turning radius. FIG. 5(c) shows a turning center when the rear-wheel steering angle is out-of-phase with the front-wheel steering angle in a vehicle equipped with a rear-wheel steering system. The effective wheelbase of the vehicle is short, so it becomes easy to rotate in a narrow space. That is, the turning radius is small, so it is advantageous in sudden cornering or parking.

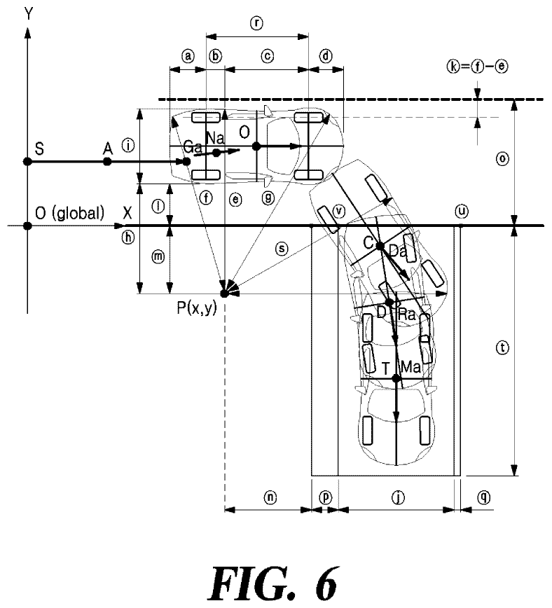

FIG. 6 is a diagram illustrating a first route generation method according to an embodiment of the present disclosure.

The first route generation method is a method of generating an available automotive parking route on the basis of the specifications of an individual vehicle by creating a map for parking spaces and for parking using surrounding information provided from a parking control center, information in a navigation system, and information detected by vehicle sensors without using an artificial intelligence model.

The parking route setting unit 110 can generate an autonomous parking route using information of vehicle specifications, information of the road width in a parking facility, information of the extra spaces around a target parking space, etc. When there is an extra empty space around a target parking space or there is an extra empty space on the opposite road in a parking facility, the parking route setting unit 110 can generate an autonomous parking route using the empty space (first route generation method).

The process of setting a parking route is described on the basis of front-wheel parking in the specification, but the present disclosure is not limited thereto.

It is possible to calculate a length for setting a parking route using parking space conditions and vehicle specifications. In FIG. 6, the hatched area (space \textcircled{p}) is an available extra space, which may not be present when parking. Based on the initial global coordinates, parking lines, parking spaces, centerlines, extra spaces, etc. are represented in the map.

Referring to FIG. 6, a turning center P(x, y) of the vehicle with the smallest radius from the vehicle center O is set using the thread \textcircled{i}, the wheelbase \textcircled{r}, and the maximum steering angles of the front and rear wheels.

Areas \textcircled{k}, \textcircled{e}, \textcircled{f}, and \textcircled{g} where the vehicle encroaches upon the centerline of the road while turning around the turning center P(x, y) are calculated using the tread \textcircled{i}, the wheelbase \textcircled{r}, the rear overhang \textcircled{a}, and the front overhang \textcircled{d}. In this case, \textcircled{k} is the distance deviating from the vehicle line when the vehicle turns, \textcircled{e} is the perpendicular distance from the turning center to the end, \textcircled{f} is the turning radius of the end of the rear bumper when turning, and \textcircled{g} is the turning radius of the end of the front bumper when turning.

The distance (\textcircled{l}=\textcircled{o}−\textcircled{k}−\textcircled{i}) between the road boundary and the vehicle and the distance (\textcircled{m}=\textcircled{e}−\textcircled{l}−\textcircled{i}) between the road boundary and the turning center are calculated using the width \textcircled{o} of the road and the tread \textcircled{i} of the vehicle.

The maximum value of \textcircled{n} that does not cause interference up to the nearest proximity point \textcircled{s} is calculated in consideration of the extra empty space (hatched area in FIG. 3) inside the turning direction from the turning center P when the vehicle turns (\textcircled{n}=\textcircled{g}−\textcircled{p}−(\textcircled{j}−\textcircled{q})) (the maximum value of \textcircled{n} can be calculated using \textcircled{l}+\textcircled{m}≥\sqrt{\textcircled{m}²+\textcircled{n}²}. In this case, \textcircled{n} refers to the minimum distance from the turning center that is required when the vehicle rotates at the shortest distance \textcircled{h} between the vehicle and the turning center.

A minimum distance (\textcircled{p}=\textcircled{g}−\textcircled{j}−\textcircled{n}−\textcircled{q}) for ensuring that the front bumper does not deviate from the target parking space is calculated in consideration of the minimum turning radius of the vehicle.

The points \textcircled{s}, \textcircled{u}, and \textcircled{v} are given in global coordinates on the basis of the origin. In this case, the point \textcircled{s} is a point to which the vehicle comes closest when turning.

T (Tx, Ty) is the center point of the parking space. The point T and vectors are calculated and given using the map.

The moment when the vehicle enters a parking space is the most critical point in parking. The coordinates P (Pₓ, P_{y}) of the turning center of the vehicle when the vehicle enters the parking space are expressed in global coordinates. Pₓ=\textcircled{u}−\textcircled{g}−\textcircled{q} and P_{y}=−\textcircled{m}, where \textcircled{m}=\textcircled{e}−\textcircled{l}−\textcircled{i}. When Pₓ is large, the vehicle crosses over a parking line when turning. The X-axis and the line \textcircled{g} are parallel. \textcircled{n}=\textcircled{g}−\textcircled{p}−(\textcircled{j}−\textcircled{q}), \textcircled{p} is the distance between \textcircled{s} and \textcircled{v}, and there should be \textcircled{n} that satisfies \textcircled{l}+\textcircled{m}≥\sqrt{\textcircled{m}²+\textcircled{n}²} to ensure no interference up to the point \textcircled{s}. When there is no \textcircled{n} that satisfies the condition, one-step parking is not possible, so multi-step parking has to be performed.

An example of parking route data that is set by the process described above is shown in Table 2.

TABLE 2

| | |
|---|---|
| Fmax Angle | −40.00 |
| Rmax Angle | 10.00 |
| Pₓ (from original O) | −0.85 |
| P_{y} (from original O) | −3.46 |
| O | (0, 0) |
| a | 0.66 |
| b | 0.45 |
| c | 2.15 |
| d | 0.83 |
| e | 4.36 |
| f | 4.50 |
| g | 5.28 |
| h | 2.56 |
| i | 1.80 |
| j | 2.70 |
| k | 0.14 |
| l | 1.06 |
| m | 1.50 |
| n | 2.08 |
| o | 3.00 |
| p | 0.61 |
| q | 0.10 |
| r | 2.60 |
| s | |
| t | 6.00 |

A parking route setting method is as follows. Referring to FIG. 6, a circle is drawn with P as the center. The reason for drawing a circle is that it represents an available parking route with a minimum turning radius. A straight line that is parallel with the X-axis is drawn from the start point S of the vehicle. Since the steering angle at the point where the straight line and the circle intersect is excessively large, a circle with a minimum turning radius that is tangent to the straight line and the circle is drawn. The points of contact are A and B. The points A, B, and C are the rotation centers of the vehicle obtained by dropping perpendiculars from the turning center to the X-axis (center axis) of the vehicle rather than the center of the vehicle. The movement path of the vehicle center can be set as a route passing through S, Ga, Na, Da, Ra, and Ma. The sections S and GA are straight movement routes. The sections Ga-Na and Na-Da are rotational movement routes with the minimum radius.

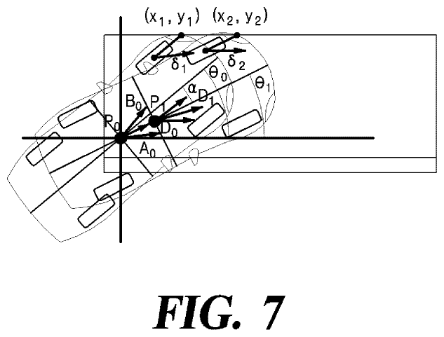

FIG. 7 is a diagram illustrating a process of setting a parking route of the section Da-Ra of FIG. 6.

In the section Da-Ra, the center point of the vehicle is calculated until the center of the rear-right wheel reaches the center of the opposite parking line while aligning the front-left end point of the vehicle with a parking line. A vehicle reference coordinate system is set with P₀ (the vehicle center point) as the origin. Coordinate transformation is performed by moving and rotating the origin around the point P₀. Since the front end point of the vehicle follows the parking line, the same y-value is maintained. d is the minimum unit movement distance for a T-sample time. For example, it may be 1 cm per looms. A is the direction vector of the left-front wheel, B is the direction vector of the right-rear wheel, and D is the direction vector of the vehicle center. δ is the angle between the center axis of the vehicle and the vector A. δ changes with movement of the vehicle. E is the angle between the center axis of the vehicle and the vector B. ϵ is constant regardless of movement of the vehicle. The coordinates (x₁,y₁) represent the position of the left end of the vehicle and the coordinates of the vehicle center are determined accordingly. The left end point of the vehicle moves while maintaining the same position as the y-value, so the x₁ value changes and the y₁ value is constant. In order to move from (x₁,y₁) to (x₂,y₁), it is required to rotate by a certain value of α and travel straightly by d. d is a predetermined value. θ₀ is a known value in advance, so the value of α can be calculated and then the value of x₂ is calculated.

For example, the value of x₂ can be calculated as in Equation 1.

$$[ \begin{matrix}{x}_{2} \\ {y}_{1} \\ 1\end{matrix} ] = [ \begin{matrix}cos ( - α ) & - sin ( - α ) & d cos {θ}_{1} \\ sin ( - α ) & cos ( - α ) & d sin {θ}_{1} \\ 0 & 0 & 1\end{matrix} ] [ \begin{matrix}{x}_{1} \\ {y}_{1} \\ 1\end{matrix} ] \qquad [ Equation 1 ]$$

$$α = {θ}_{0} - {θ}_{1} , {θ}_{1} = {θ}_{0} - α$$

$${y}_{1} = - {x}_{1} sin α + {y}_{1} cos α + d sin ( {θ}_{0} - α ) = - {x}_{1} sin α + {y}_{1} cos α + d sin {θ}_{0} cos α - d sin α cos {θ}_{0}$$

$${y}_{1} = ( - {x}_{1} - d cos {θ}_{0} ) sin α + ( {y}_{1} + d sin {θ}_{0} ) cos α$$

$${y}_{1} = \sqrt{{( - {x}_{1} - d cos {θ}_{0} )}^{2} + {( {y}_{1} + d sin {θ}_{0} )}^{2}} cos ( α - β )$$

$$( sin β = \frac{- {x}_{1} - d cos {θ}_{0}}{\sqrt{{( - {x}_{1} - d cos {θ}_{0} )}^{2} + {( {y}_{1} + d sin {θ}_{0} )}^{2}}} , cos β = \frac{{y}_{1} + d sin {θ}_{0}}{\sqrt{{( - {x}_{1} - d cos {θ}_{0} )}^{2} + {( {y}_{1} + d sin {θ}_{0} )}^{2}}} )$$

$$α = a cos ( \frac{{y}_{1}}{\sqrt{{( - {x}_{1} - d cos {θ}_{0} )}^{2} + {( {y}_{1} + d sin {θ}_{0} )}^{2}}} ) + β$$

$${x}_{2} = {x}_{1} cos α + {y}_{1} sin α + d cos ( {θ}_{0} - α )$$

where the value of α is a counterclockwise rotation angle and α>0. The directional angle (θ₀−α) of P₀ is converted with respect to x-axis in the global coordinate system and then stored as parking route data along with the coordinates of P₀. The global coordinates of P₁ are obtained by adding movement distance values (d cos(θ₀−α) and d sin(θ₀−α) to the coordinates of P₀ after coordinate transformation, and then stored as parking route data.

Movement of the left-front end point of the vehicle from (x₂, y₁) to (x₃, y₁) can be obtained by performing rotation transformation by the value of a and translation transformation by d (d cos θ₂ and d sin θ₂). The center point and the directional angle of the vehicle are calculated until the center of the rear-right wheel reaches the center of the opposite parking line while aligning the front-left end point of the vehicle with a parking line, and are stored as parking route data.

In the section Ra-Ma, the turning center is calculated using two vectors and a rotation route is set around the turning center point.

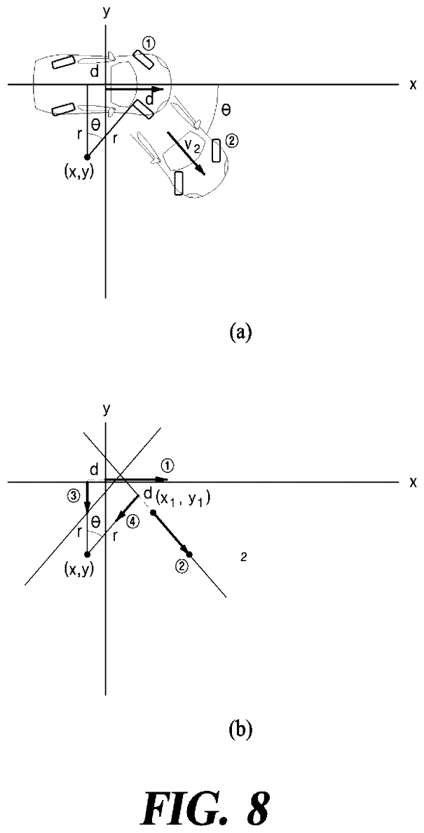

FIG. 8 is a diagram illustrating a process of calculating a turning center point of a vehicle.

Referring to FIG. 8, when a first direction vector v₁ and a second direction vector v₂ are calculated as in Equation 2, the rotation center point (x, y) of the vehicle is calculated under the assumption that the vehicle rotates by θ with a radius r around the rotation center point (x, y) of the vehicle. In this case, θ is the angle between the second direction vector v₂ and the x-axis, that is, the difference between the direction angle of the first direction vector and the second direction vector v₂, and r is the distance between the rotation center point of the vehicle and the vehicle center. (x₁, y₁) is the starting point of the second direction vector v₂ and represents the coordinates of the vehicle center.

$${v}_{1} = [ \begin{matrix}1 & 0 \\ 0 & 0 \\ 1 & 1\end{matrix} ] \qquad [ Equation 2 ]$$

$${v}_{2} = [ \begin{matrix}{x}_{2} & {x}_{1} \\ {y}_{2} & {y}_{1} \\ 1 & 1\end{matrix} ]$$

$${R}_{1} = [ \begin{matrix}cos θ & - sin θ & 0 \\ sin θ & cos θ ) & 0 \\ 0 & 0 & 1\end{matrix} ]$$

$${T}_{d} = [ \begin{matrix}1 & 0 & d \\ 1 & 1 & 0 \\ 0 & 0 & 1\end{matrix} ]$$

$${T}_{x} = [ \begin{matrix}1 & 0 & {x}_{1} + d cos θ \\ 0 & 1 & {y}_{1} + d sin θ \\ 0 & 0 & 1\end{matrix} ]$$

Translation and rotation transformations are performed on the first direction vector v₁, as in Equation 3, whereby v₃ and v₄ are obtained.

$${v}_{3} = {T}_{d} * {R}_{1} ( - \frac{π}{2} ) * {v}_{1} = [ \begin{matrix}d & d \\ - 1 & 0 \\ 1 & 1\end{matrix} ] = [ {p}_{1} , {p}_{2} ] \qquad [ Equation 3 ]$$

$${v}_{4} = {T}_{x} * {R}_{1} ( θ ) * ( - {T}_{d} ) * {v}_{3} = [ \begin{matrix}sin θ + d cos θ + {x}_{1} & d cos θ + {x}_{1} \\ - cos θ + d sin θ + {y}_{1} & d sin θ + {y}_{1} \\ 1 & 1\end{matrix} ] = [ {p}_{3} , {p}_{4} ]$$

The coordinates of an intersection are obtained by performing a cross product operation, as in FIG. 4, on the basis of the starting points and end points of v₃ and v₄.

$${v}_{cross product} = ( {p}_{2} \times {p}_{1} ) \times ( {p}_{3} \times {p}_{4} ) = \\ [ \begin{matrix}1 \\ 0 \\ - d\end{matrix} ] \times [ \text{} \begin{matrix}- cos θ \\ - sin θ \\ {x}_{1} cos θ + {y}_{1} sin θ + d\end{matrix} ] = \\ [ \text{} \begin{matrix}- d sin θ \\ d cos θ - {x}_{1} cos θ - {y}_{1} sin θ + d \\ - sin θ\end{matrix} ] \text{} = \\ - sin θ [ \begin{matrix}d \\ \frac{( {x}_{1} - d ) cos θ}{sin θ} + {y}_{1} + d / sin θ \\ 1\end{matrix} ] \qquad [ Equation 4 ]$$

$$coordinates of intersection : [ \begin{matrix}d \\ \frac{( {x}_{1} - d ) cos θ}{sin θ} + {y}_{1} + d / sin θ \\ 1\end{matrix} ]$$

The variable d is calculated, as in Equation 5, using the fact that the distances r from a first waypoint and a second waypoint of the rotation center point of the vehicle are the same.

$${r}^{2} = {( \frac{( {x}_{1} - d ) cos θ}{sin θ} + d / sin θ + {y}_{1} )}^{2} = {( d - {x}_{1} - d cos θ )}^{2} + {( \frac{( {x}_{1} - d ) cos θ}{sin θ} + d / sin θ - sin θ )}^{2} \qquad [ Equation 5 ]$$

$$d = \frac{{y}_{1}^{2} + 2 {x}_{1} {y}_{1} \frac{cos θ}{sin θ} - {x}_{1}^{2}}{2 ( {y}_{1} \frac{cos θ}{sin θ} - \frac{{y}_{1}}{sin θ} - {x}_{1} )}$$

When the value of d is obtained through the process described above, the coordinates of the rotation center point of the vehicle can be obtained by substituting the coordinates (x₁, y₁) of the second waypoint and B.

For example, when the starting point of the second vector v₂ is (1, −1) and θ is

$$- \frac{π}{4} ,$$

d can be calculated to be

$$- \frac{\sqrt{2}}{2}$$

using Equation 5 and the coordinates (x, y) of the rotation center point of the vehicle can be calculated to be

$$( - \frac{\sqrt{2}}{2} , - 1 , - \frac{\sqrt{2}}{2} )$$

using Equation 4.

In the case of a vehicle of which the rear wheels are not steered, the value of d is fixed as the distance between the vehicle center and the center of the rear axle. This is because the rotation center point of a vehicle of which only the front wheels can be steered, as in FIG. 5(b), is on the extension line of the rear axle.

The parking route tracking unit 120 can calculate the individual wheel steering angles, the turning radius, and the individual wheel power frequencies of a vehicle using the calculated turning center point of the vehicle.

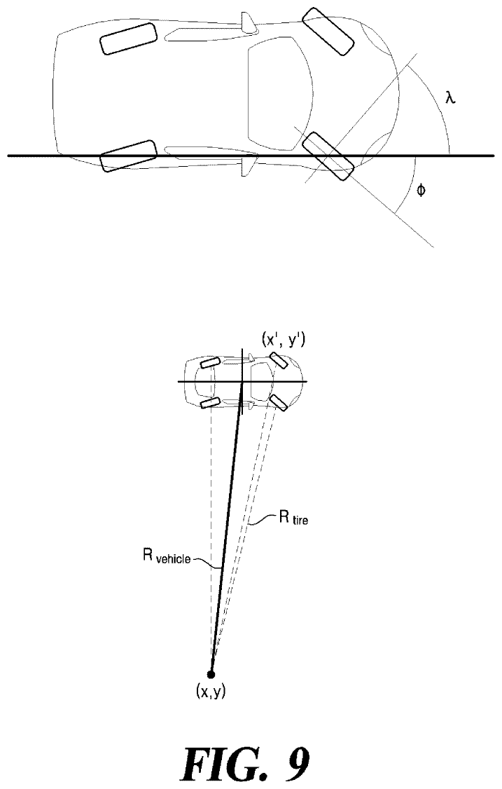

FIG. 9 is a diagram illustrating a process of calculating individual wheel steering angles of a vehicle.

Referring to FIG. 9, it is possible to calculate individual wheel steering angles and individual wheel rotation radii on the basis of the turning center of the vehicle and the center position of each wheel. The individual steering angles can be obtained, as in Equation 6.

$${φ}_{tire} = λ - \frac{π}{2} , λ = {tan}^{- 1} ( \frac{{y}^{′} - y}{{x}^{′} - x} ) \qquad [ Equation 6 ]$$

where φₜᵢᵣₑ is an individual wheel angle, (x′, y′) is an individual wheel center position, and (x, y) is the coordinates of the turning center point of a vehicle. The turning radius of a vehicle R_{vehicle} can be obtained, as in Equation 7, on the basis of the positions of the turning center point of the vehicle and the vehicle center point.

$${R}_{v e h i c l e} = \sqrt{{x}^{2} + {y}^{2}} \qquad [ Equation 7 ]$$

The individual wheel turning radius Rₜᵢᵣₑ can be obtained, as in Equation 8, on the basis of the positions of the rotation center point of the vehicle and individual wheel center of the vehicle.

$${R}_{tire} = \sqrt{{( {y}^{′} - y )}^{2} + {( {x}^{′} - x )}^{2}} \qquad [ Equation 8 ]$$

The parking route tracking unit 120 calculates an individual wheel power frequency on the basis of an individual wheel rotation radius and a required speed. In this case, the required speed refers to the minimum value of a speed limit or a speed set by a user. The speed limit refers to the maximum speed at which a rollover due to the rotation radius of a vehicle does not occur.

The parking route tracking unit 120 can calculate the angular speed of a vehicle on the basis of the rotation radius and required speed of the vehicle, can calculate an individual wheel speed using the angular speed of the vehicle and an individual wheel rotation radius, and can calculate an individual wheel power frequency on the basis of the individual wheel speed and the individual wheel radius.

An angular speed of each wheel is the same as the angular speed ω of the vehicle center. The speed of each wheel Vₜᵢᵣₑ is proportional to an individual wheel rotation radius Rₜᵢᵣₑ. That is, an individual wheel speed is determined, as in Equation 9, by an individual wheel rotation radius and the angular speed of a vehicle.

$$ω = \frac{V}{{R}_{vehicle}} , {V}_{tire} = {R}_{tire} \cdot ω \qquad [ Equation 9 ]$$

where V is a required speed.

An individual wheel power frequency fₜᵢᵣₑ can be obtained, as in Equation 10, from each tire radius Rₜᵢᵣₑ and an individual wheel speed Vₜᵢᵣₑ.

$${f}_{tire} = \frac{{V}_{tire}}{{r}_{tire} \cdot 2 π} \qquad [ Equation 10 ]$$

$${V}_{tire} = {r}_{tire} \cdot ω = {r}_{tire} \cdot 2 {π f}_{tire}$$

While a vehicle moves from a first waypoint to a second waypoint in each step, the parking route tracking unit 120 outputs individual wheel steering angles pₜᵢᵣₑ to a corresponding steering system and applies the power of individual wheel power frequencies to corresponding in-wheel motors. In this case, the time it takes for a vehicle to move from a first waypoint to a second waypoint in each step can be obtained, as in Equation 11, on the basis of the direction angle θ between the second direction vector v₂ and the x-axis, and the rotation radius R_{vehicle} and the required speed V of the vehicle.

$$t = \frac{{R}_{vehicle} θ}{V} ( V = \frac{{R}_{vehicle} θ}{t} ) \qquad [ Equation 11 ]$$

The parking route tracking unit 120 repeatedly performs the process described above in each step until the vehicle reaches the parking completion point.

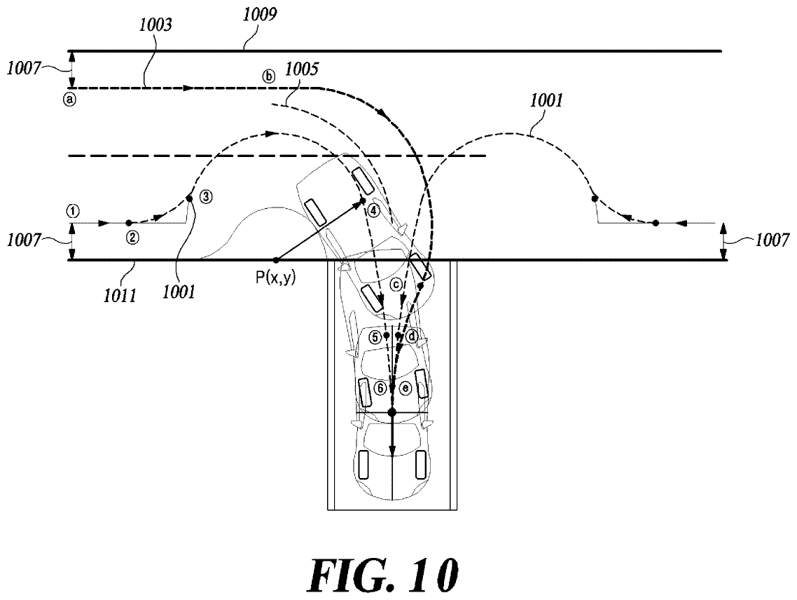

FIG. 10 is a diagram illustrating a process of setting an autonomous parking route range of the first route generation method.

Referring to FIG. 10, a vehicle can set the range of an autonomous parking route to perform autonomous parking. It is possible to set a route using a minimum turning radius (hereafter, nearest parking route 1001) when approaching a parking line 1011 that is in contact with a parking space and a route using a minimum turning radius (hereafter, outermost parking route 1003) when approaching an allowable parking line 1009 on the opposite side of the parking space. It is also possible to set a route 1005 with a large turning radius within the range in which the routes using the minimum turning radii are set.

For a minimum turning radius of a vehicle, it can be assumed that the rear-wheel steering angle of a vehicle equipped with a rear-wheel steering system is out-of-phase with the front-wheel steering angle, but the present disclosure is not limited thereto.

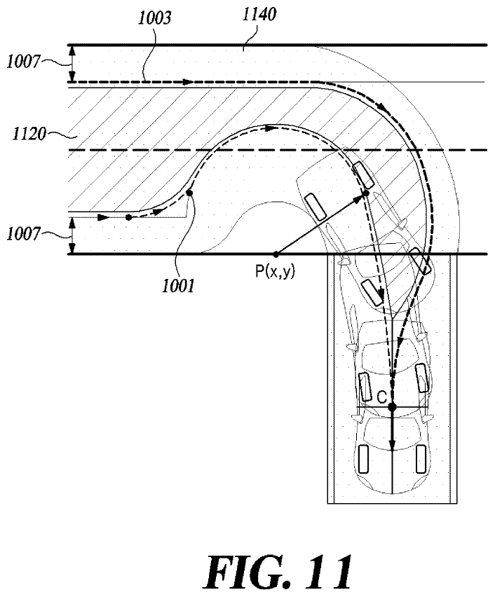

FIG. 11 is a diagram illustrating an area where a vehicle center can be positioned and an area where the outermost part of the vehicle can be positioned.

Referring to FIG. 11 and FIG. 10, the area surrounded by the nearest parking route 1001 and the outermost parking route 1003 can be defined as an area (hatched part, 1120) in which a vehicle center can be positioned. By setting an area, which the rear corner of the vehicle does not reach, at a distance 1007 from the vehicle center in the outward direction from the area 1120 in which the vehicle center can be positioned, the area can be defined as the area 1140 in which the outermost part of the vehicle can be positioned.

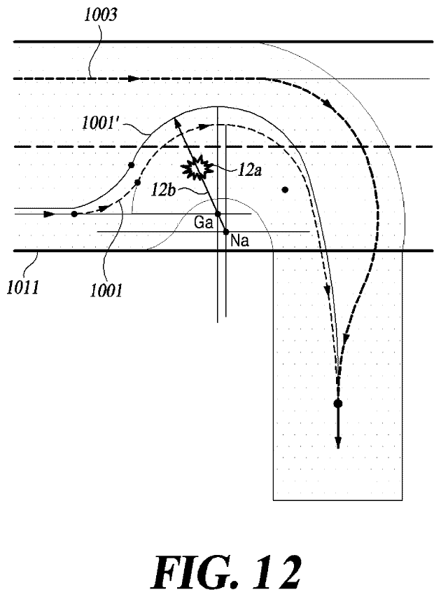

FIG. 12 is a diagram illustrating a process in which a parking route is changed when an obstacle occurs inside a nearest parking route.

Referring to FIG. 12, when an obstacle 12a occurs on the movement line of the outer part of a vehicle traveling on the nearest parking route 1001, it is required to change the parking route so that the outer part of the vehicle can avoid the obstacle 12a. Accordingly, it is possible to change the parking route by drawing a straight line 12b from the turning center (Na in FIG. 12) of the vehicle to the obstacle 12a and then moving the turning center toward the straight line 12b (Ga in FIG. 12) (1001′).

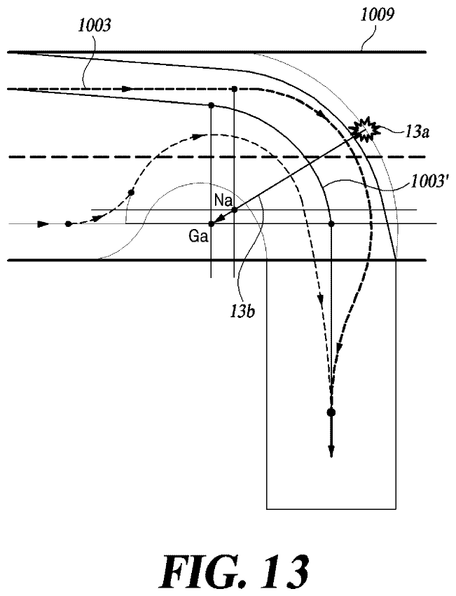

FIG. 13 is a diagram illustrating a process in which a parking route is changed when an obstacle occurs outside a vehicle on an outermost parking route.

Referring to FIG. 13, when an obstacle 13a occurs on the movement line of the outer part of a vehicle traveling on the outermost parking route 1003, it is required to change the parking route so that the outer part of the vehicle can avoid the obstacle 13a. Accordingly, it is possible to change the parking route by drawing a straight line 13b from the turning center (Na in FIG. 13) of the vehicle to the obstacle 13a and then moving the turning center in the opposite direction of the straight line 13b (Ga in FIG. 13) (1003′).

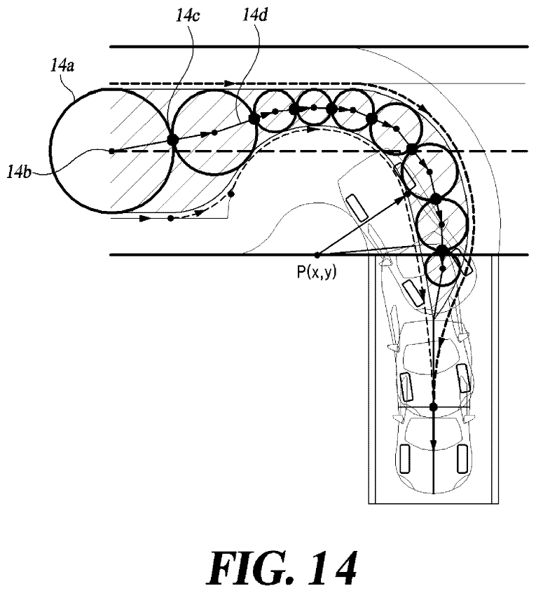

FIG. 14 is a diagram illustrating a process of setting a one-step parking route according to an embodiment of the present disclosure.

When there is a space between the nearest parking route 1001 and the outermost parking route 1003, parking is possible in a single attempt (one-step parking). Referring to FIG. 14, circles 14a are drawn in the area in which a vehicle center can be positioned, and the center points 14b of the circles and the points of tangency of the circles define a parking route. For parking stability, it is possible to set a route while leaving a slight clearance and reducing it around the movement path of the vehicle center. When the clearance is wide, the vehicle can drive quickly, and when it is narrow, the vehicle drives slowly. The starting point of the arrows 14d represents the departure position at each moment, the size thereof represents the distance traveled at each moment, and the direction thereof represents the movement direction at each moment.

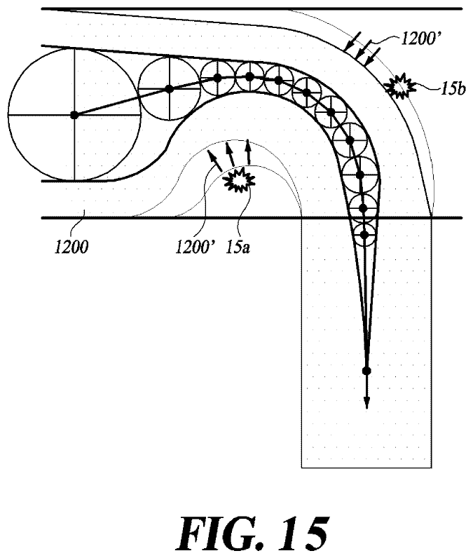

FIG. 15 is a diagram illustrating a process of reducing the range of an available parking route when an obstacle occurs in a one-step parking route.

Referring to FIG. 15, the area combining an area 1120 in which a vehicle center can be positioned and an area 1140 in which the outermost part of the vehicle can be positioned is defined as a range 1500 of an available parking route. When an obstacle occurs in the available parking route range (15a or 15b in FIG. 15), it is possible to reduce the range of the available parking route (1200′) by reducing the nearest parking route 1001 or the outermost parking route 1003 (1001′ or 1003′) using the method described above.

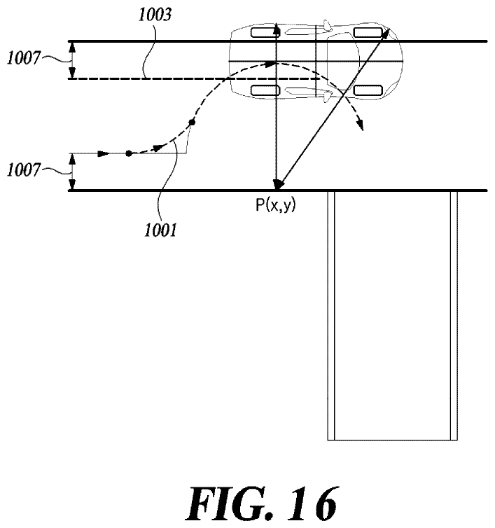

FIG. 16 is a diagram illustrating the case when one-step parking is not possible.

Referring to FIG. 16, when the width of a road decreases and the outermost parking route 1003 encroaches upon the minimum turning route of the nearest parking route 1001, one-step parking is not possible. Accordingly, multi-step parking should be considered.

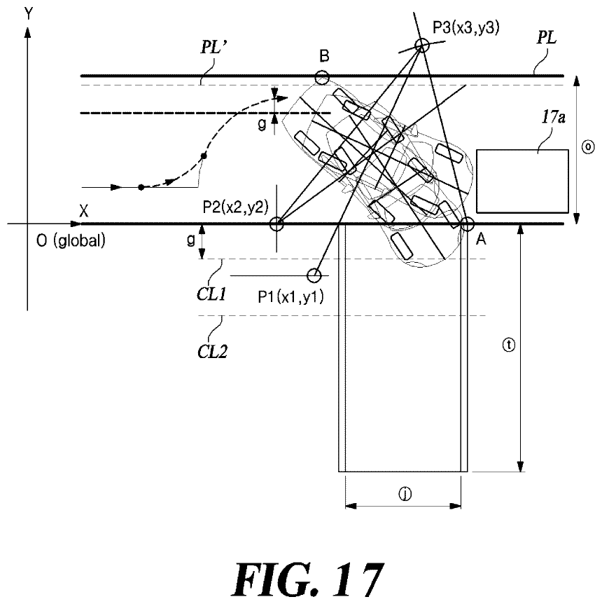

FIG. 17 is a diagram illustrating a multi-step parking process when there is an obstacle in front of a parking space.

Referring to FIG. 17, the values of P₁(x₁, y₁), P₂(x₂, y₂), and P₃(x₃, y₃) can be calculated, as described above, using the width \textcircled{j} of the parking space, the depth \textcircled{t} of the parking space, and the vehicle specifications with reference to FIG. 16. The minimum road width \textcircled{o} is determined by P₂ and P₃. The line where the left-rear corner of a vehicle having the turning center at P₂ and P₃ makes contact is a parking limit line (PL in FIG. 17). If the vehicle encroaches upon a dotted line (PL′ in FIG. 17), it is not possible to set an available parking route.

P₁ is the turning center point at the initial entry when one-step parking is not possible. A is the portion with which the right-front corner comes in contact at the initial entry. P₁ is a point symmetric to the vehicle center axis from P₂ and the distance from P₁ to P₂ is twice the minimum turning radius. P₂ is an intersection of circles centered at P₃ and A and having a radius that is the distance to P₂. This can be obtained using the equation of a circle. The distance from P₂ to P₃ is twice the minimum turning radius. The distance from P₂ to A is a value that is determined under the condition of the minimum turning radius. P₂ is a point symmetric to P₁ with respect to the vehicle center axis. The distance from P₂ to P₁ is twice the minimum turning radius.

P₃ is the center point of a boundary turning route among the parking routes when one-step entry is possible. In this case, the boundary turning route refers to a turning route having the smallest radius value among the parking routes using the minimum turning radius.

Referring to FIG. 17, when there is an obstacle (17a in FIG. 17) in front of the parking space, the vehicle center is offset by the minimum turning radius from the axis y=y₁ and moves in a straight line or a curved path until the minimum turning center reaches P₁. When the minimum turning center reaches P₁, the vehicle turns around P₁ such that the right-front corner reaches the point A. The vehicle turns backward until P₁ that is a point symmetric to P₃ with respect to the vehicle axis reaches P₂. However, the end point should not cross B. The vehicle turns forward around P₂ such that the left edge reaches A. Finally, three-step parking is completed using the process of setting the parking route of the section Da-Ra in FIG. 6 described above. When three-step parking is possible, the y-coordinate of P₁ is present between CL1 and CL2 in FIG. 17. CL1 in FIG. 17 is an upper boundary line of the y-value when parking is possible and CL2 in FIG. 17 is a lower boundary line of the y-value when parking is possible.

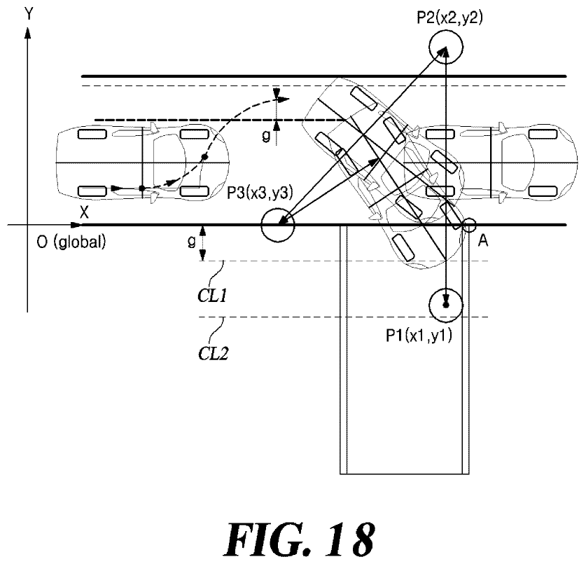

FIG. 18 is a diagram illustrating a multi-step parking process when there is no obstacle in front of a parking space.

Referring to FIG. 18, when there is no obstacle in front of a parking space, the vehicle center is offset by the minimum turning radius from the axis y=y₂ and the vehicle moves in a straight line or a curved path until the minimum turning center reaches P₂. When the minimum turning center reaches P₂, the vehicle turns backward around P₂ until P₁ that is a point symmetric to P₂ with respect to the vehicle axis reaches P₃. The vehicle turns forward around P₃ such that the left edge reaches A. Finally, three-step parking is completed using the process of setting the parking route of the section Da-Ra in FIG. 6 described above.

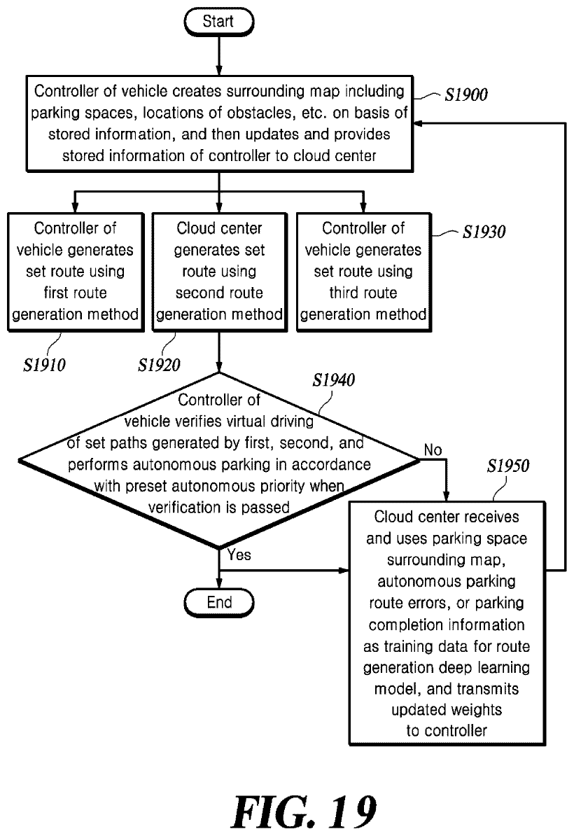

FIG. 19 is a flowchart schematically showing a method for setting an autonomous parking route according to an embodiment of the present disclosure.

The controller 100 of a vehicle creates a surrounding map including parking spaces and the locations of obstacles on the basis of stored information such as a maximum parking step setting value, parking facility information, route generation deep learning training information (weight), vehicle specifications, vehicle sensor information, and a parking route generation setting value. The information of the map including parking spaces and the locations of obstacles is provided to the parking route setting unit of the controller of the vehicle and a cloud center (S1900).

The parking route setting unit 110 of the controller of the vehicle sets an available parking route range and then determines a set route using the first route generation method on the basis of the updated surrounding map including parking spaces and the locations of obstacles (S1910).

The first route generation method is a method of generating an available automotive parking route on the basis of the specifications of an individual vehicle by creating a map for parking spaces and for parking using information around a vehicle provided from a parking control center 14, information stored in a navigation system, information detected by vehicle sensors, etc.

The cloud center 14 transmits a set route, which is generated by the second route generation method on the basis of the information provided from the controller of the vehicle, to the controller of the vehicle (S1920).

The second route generation method is for the case when the cloud center 14 functions as a parking control center, and generates an autonomous parking path using the spatial recognition deep learning model 212 and then determines a set route.

The spatial recognition deep learning model 212 is a map of a parking facility that is managed by the cloud center 14, target data are learned in advance using people (2b of FIG. 2), vehicles (2c of FIG. 2), empty spaces (2d of FIG. 2), and other objects, and weights are updated through periodic learning. The spatial recognition deep learning model detects and classifies people, vehicles, and other objects on the basis of the updated parking space and surrounding map transmitted from the controller of the vehicle, and transmits the information to the available parking space determination module 214. The available parking space determination module 214 transmits information about available parking spaces and empty spaces to the comparison algorithm module 216 on the basis of the information transmitted from the spatial recognition deep learning model. The comparison algorithm module 216 compares parking routes that can be generated in the area transmitted from the available parking space determination module with parking route generation history information that is managed by the cloud center, thereby transmitting an available parking route as a set route to the controller 100 of the vehicle. In this case, the parking route generation history information includes the parking route ranges, generated routes, virtual driving results, actual parking completion results, etc. of all kinds of vehicles with which the cloud center 14 communicates.

The controller 100 of the vehicle generates a set route through the third route generation method using a route generation deep learning model (S1930). The third route generation method is the same as the second route generation method, but is different in that it is performed by the controller of the vehicle and the route generation model installed in the controller of the vehicle does not require separate deep learning training. However, periodically updated weights are transmitted from the cloud center 14, so a route is generated using stored weights 232.

The controller of the vehicle verifies virtual driving along the set routes generated by the first, second, and third route generation methods, determines available autonomous parking routes, and then determines the passed routes as the set routes. Finally, autonomous driving is performed in accordance with a pre-set autonomous parking priority (S1940). For the pre-set autonomous parking priority, a setting value for max-step parking can be determined in advance in accordance with user's configuration. For example, one-step parking can be prioritized and multi-step parking can be set as a lower priority.

When autonomous parking is successfully performed, the cloud center 14 receives parking completion information, a map around the parking space, etc. from the controller of the vehicle as training data for the deep learning model. When autonomous parking ends in failure, it receives autonomous parking route error information, a map around the parking space, etc. as training data for the deep learning model. The cloud center 14 trains the route generation deep learning model on the basis of the received information and transmits updated weights to the controller (S1950).

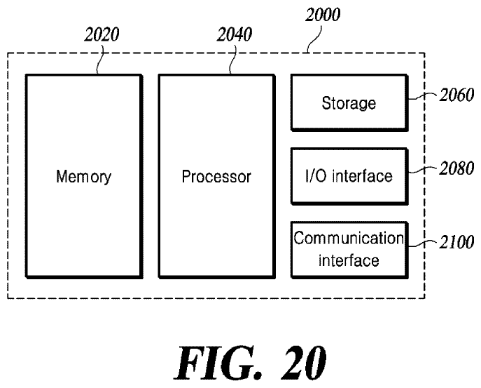

FIG. 20 is a diagram schematically showing the configuration of an exemplary computing device that can be used to implement the apparatus and method described in the present disclosure.

A computing device 2000 may include some or all of a memory 2020, a processor 2040, a storage 2060, an I/O interface 2080, and a communication interface 2100. The computing device 2000 may not only be a stationary compute device such as a desktop computer and a server, but also a mobile computing device such as a laptop computer and a smartphone. The computing device 2000 may include any specialized hardware accelerator capable of efficiently processing computations for an artificial intelligence model. For example, the computing device 2000 may include a Graphics Processing Unit (GPU), a Tensor Processing Unit (TPU), or a Neural Processing Unit (NPU).

The memory 2020 can store programs making the processor 2040 perform methods or operations according to various embodiments of the present disclosure. For example, the program may include a plurality of commands that is executable by the processor 2040, and the method or operations described above can be performed by executing the plurality of commands through the processor 2040. The memory 2020 may be a single memory or a plurality of memories. In this case, the information for performing the methods or operations according to various embodiments of the present disclosure may be stored in a single memory or may be separately stored in a plurality of memories. When the memory 2020 is composed of a plurality of memories, the plurality of memories may be physically separated. The memory 2020 may include at least one of a volatile memory or a nonvolatile memory. The volatile memory includes a Static Random Access Memory (SRAM), a Dynamic Random Access Memory (DRAM), or the like, and the nonvolatile memory includes a flash memory, etc.

The processor 2040 may include at least one core that can execute at least one command. The processor 2040 can execute the commands stored in the memory 2020. The processor 2040 may be a single processor or a plurality of processors.

The storage 2060 retains stored data even if power supplied to the computing device 2000 is cut off. For example, the storage 2060 may include a nonvolatile memory and may include storage media such as a magnetic tape, an optical disc, and a magnetic disc as well. The programs stored in the storage 2060 can be loaded into the memory 2020 before they are executed by the processor 2040. The storage 2060 can store files written in programming languages, and programs generated from those files by a compiler can be loaded into the memory 2020. The storage 2060 can store data to be processed by the processor 2040 and/or data processed by the processor 2040.

The I/O interface 2080 may provide an interface for input devices such as a keyboard and a mouse and/or may include output devices such as a display device and a printer. A user can trigger execution of programs by the processor 2040 through an input device and/or can check the processing results by the processor 2040 through an output device.

The communication interface 2100 can provide access to an external network. The computing device 2000 can communicate with other devices through the communication interface 2100.

Each component of the apparatus or method according to the present disclosure may be implemented as hardware or software, or a combination of hardware and software. Further, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an embodiment of the present disclosure. In other words, since it is apparent to those skilled in the art that an order described in the flowchart/timing diagram may be changed or one or more processes may be executed in parallel without departing from the essential characteristics of an embodiment of the present disclosure, the flowchart/timing diagram is not limited to a time-series order.

Although exemplary embodiments of the present disclosure have been described for illustrative purposes, those skilled in the art will appreciate that various modifications, additions, and substitutions are possible, without departing from the idea and scope of the claimed disclosure. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed disclosure is not to be limited by the above explicitly described embodiments but by the claims and equivalents thereof.

What is claimed is:

1. A computer-implemented method for setting an autonomous parking route, the method comprising:
generating an autonomous parking route by a first route generation method using a parking space and a surrounding space;
generating an autonomous parking route by a second route generation method using a cloud center and a pre-trained spatial recognition deep learning model;
generating an autonomous parking route by a third route generation method using a pre-trained route generation deep learning model installed in a controller of a vehicle;
performing virtual driving along the routes generated by the first, second, and third route generation methods; and
determining set routes in accordance with a preset route priority in the vehicle performing autonomous parking for passed routes when the virtual driving is passed.

2. The computer-implemented method of claim 1, wherein the first route generation method comprises:
creating a map corresponding to the parking space and the surrounding space based at least on using vehicle specifications, parking facility information, vehicle sensor information, and vehicle specifications stored in advance in a controller of the vehicle performing autonomous parking;
generating a parking route range by setting a nearest parking route and an outermost parking route on the basis of at least the parking space and surrounding map; and
generating information about locations of waypoints along which the vehicle will move in the parking route range, and information about a directional angle of each of the waypoints,
wherein the nearest parking route is a route that is close to a parking line, which is in contact with a parking space, and that uses a minimum turning radius, and
the outermost parking route is a route that is close to an allowable parking line at the opposite side of the parking space and uses a minimum turning radius, and is a route from a current location of the vehicle to a parking completion point.

3. The computer-implemented method of claim 1, wherein the second route generation method comprises the cloud center, which receives a map corresponding to a parking space and a surrounding space based at least on using vehicle specifications, parking facility information, vehicle sensor information, and vehicle specifications stored in advance in a controller of the vehicle performing autonomous parking, and generates information about locations of waypoints along which the vehicle will move and information about a directional angle of each of the waypoints, using the pre-trained spatial recognition deep learning model.

4. The computer-implemented method of claim 1, wherein the third route generation method is a method of generating information about locations of waypoints along which the vehicle performing autonomous parking will move and information about a directional angle of each of the waypoints, using the pre-trained route generation deep learning model installed in a controller of the vehicle performing autonomously on the basis of a map corresponding to a parking space and a surrounding space based at least on using vehicle specifications, parking facility information, vehicle sensor information, and vehicle specifications stored in advance in the controller of the vehicle.

5. The computer-implemented method of claim 2, further comprising reducing the nearest parking route or the outermost parking route when an obstacle is detected in the parking route range such that the obstacle is not included in a range of an available parking route.

6. The computer-implemented method of claim 2, further comprising:
performing one-step parking including determining circles with respect to a vehicle center to completely fill the parking route range, wherein waypoints of a parking route are respectively based at least on center points of the circles and points of tangency of the circles; and
performing multi-step parking when the one-step parking is not possible.

7. The computer-implemented method of claim 3, wherein using the pre-trained spatial recognition deep learning model includes transmitting information determined based on perceiving and classifying people, vehicles, other objects, and empty spaces from the parking space and surrounding map received from a vehicle communicating with the cloud center using the spatial recognition deep learning model, to an available parking space determination module;
the available parking space determination module performs transmitting information of a location of a subject vehicle, available parking spaces, and the empty spaces to a comparison algorithm module on the basis of the information received from the spatial recognition deep learning model; and
the comparison algorithm module comprises a process of generating an available autonomous parking route by comparing the information received from the available parking space determination module with a parking route generation history that the cloud center manages, and of transmitting the available autonomous parking route to the vehicle with which the cloud center communicates.

8. The computer-implemented method of claim 3, wherein the spatial recognition deep learning model is a model that uses, as input of training data, maps corresponding to the parking space and surrounding spaces received from all of vehicles with which the cloud center communicates, and uses, as a target of the training data, people, vehicles, other objects, and empty spaces received from all kinds of vehicles with which the cloud center communicates.

9. The computer-implemented method of claim 4, wherein the route generation deep learning model uses a parking route range of parking route generation history information received from all of vehicles, with which a cloud center communicates, as input data of training data, and uses available route vectors as target data of the training data; and
a route generation deep learning model installed in the controller of the vehicle receives and stores weights updated as a training result of the route generation deep learning model from the cloud center.

10. The computer-implemented method of claim 1, further comprising transmitting a parking route range, the created routes, and actual parking results, as results of the virtual driving, to a cloud center that communicates with the vehicle performing autonomous parking.

11. An apparatus comprising:
at least one memory storing commands; and
at least one processor,
wherein the at least one processor, by executing the commands, performs:
generating an autonomous parking route by a first route generation method using a parking space and a surrounding space;
generating an autonomous parking route by a second route generation method using a cloud center and a pre-trained spatial recognition deep learning model;
generating an autonomous parking route by a third route generation method using a pre-trained route generation deep learning model installed in a controller of a vehicle;
performing virtual driving along the routes generated by the first, second, and third route generation methods; and
determining set routes in accordance with a preset route priority in the vehicle performing autonomous parking for passed routes when the virtual driving is passed.

12. The apparatus of claim 11, wherein the first route generation method comprises:
creating a map corresponding to the parking space and the surrounding space based at least on using vehicle specifications, parking facility information, vehicle sensor information, and vehicle specifications stored in advance in a controller of the vehicle performing autonomous parking;
generating a parking route range by setting a nearest parking route and an outermost parking route on the basis of at least the parking space and surrounding map; and
generating information about locations of waypoints along which the vehicle will move in the parking route range, and information about a directional angle of each of the waypoints,
wherein the nearest parking route is a route that is close to a parking line, which is in contact with a parking space, and that uses a minimum turning radius, and
the outermost parking route is a route that is close to an allowable parking line at the opposite side of the parking space and uses a minimum turning radius, and is a route from a current location of the vehicle to a parking completion point.

13. The apparatus of claim 11, wherein the second route generation method comprises the cloud center, which receives a map corresponding to a parking space and surrounding space based at least on using vehicle specifications, parking facility information, vehicle sensor information, and vehicle specifications stored in advance in a controller of the vehicle performing autonomous parking, and generates information about locations of waypoints along which the vehicle will move and information about a directional angle of each of the waypoints, using the pre-trained spatial recognition deep learning model.

14. The apparatus of claim 11, wherein the third route generation method is a method of generating information about locations of waypoints along which the vehicle performing autonomous parking will move and information about a directional angle of each of the waypoints, using the pre-trained route generation deep learning model installed in a controller of the vehicle performing autonomously on the basis of a map corresponding to a parking space and a surrounding space using vehicle specifications, parking facility information, vehicle sensor information, and vehicle specifications stored in advance in the controller of the vehicle.

15. The apparatus of claim 12, further performing reducing the nearest parking route or the outermost parking route when an obstacle is detected in the parking route range such that the obstacle is not included in a range of an available parking route.

16. The apparatus of claim 12, further performing:
performing one-step parking including determining circles with respect to a vehicle center to completely fill the parking route range, wherein waypoints of a parking route are respectively based at least on center points of the circles and points of tangency of the circles; and
performing multi-step parking when the one-step parking is not possible.

17. The apparatus of claim 13, wherein using the pre-trained spatial recognition deep learning model includes transmitting information determined based on perceiving and classifying people, vehicles, other objects, and empty spaces from the parking space and surrounding map received from a vehicle communicating with the cloud center using the spatial recognition deep learning model, to an available parking space determination module;
the available parking space determination module performs transmitting information of a location of a subject vehicle, available parking spaces, and the empty spaces to a comparison algorithm module on the basis of the information received from the spatial recognition deep learning model; and
the comparison algorithm module performs generating an available autonomous parking route by comparing the information received from the available parking space determination module with a parking route generation history that the cloud center manages, and of transmitting the available autonomous parking route to the vehicle with which the cloud center communicates.

18. The apparatus of claim 13, wherein the spatial recognition deep learning model is a model that uses, as input of training data, maps corresponding to the parking space and surrounding spaces received from all of vehicles, with which the cloud center communicates, and uses, as a target of the training data, people, vehicles, other objects, and empty spaces received from all kinds of vehicles, with which the cloud center communicates.

19. The apparatus of claim 14, wherein the route generation deep learning model uses a parking route range of parking route generation history information received from all of vehicles, with which a cloud center communicates, as input data of training data, and uses available route vectors as target data of the training data; and
a route generation deep learning model installed in the controller of the vehicle receives and stores weights updated as a training result of the route generation deep learning model from the cloud center.

20. The apparatus of claim 11, further performing transmitting a parking route range, the created routes, and actual parking results, as results of the virtual driving, to a cloud center that communicates with the vehicle performing autonomous parking.
